(19) United States
(12) Patent Application Publication
(10) Pub. No.: US 2024/0281471 A1
(43) Pub. Date: Aug. 22, 2024

(54) RETRIEVAL METHOD AND APPARATUS FOR GRAPH DATABASE

(71) Applicant: Alipay (Hangzhou) Information Technology Co., Ltd., Hangzhou (CN)

(72) Inventor: Tao WU, Hangzhou (CN)

(21) Appl. No.: 18/570,335

(22) PCT Filed: Oct. 14, 2022
(86) PCT No.: PCT/CN2022/125427

§ 371 Date: Dec. 14, 2023

(30) Foreign Application Priority Data
Dec. 3, 2021 (CN) 202111468911.3

(51) Int. Cl. G06F 16/901

(52) U.S. Cl. CPC G06F 16/9024

(57) ABSTRACT

Embodiments of this specification provide a retrieval method and apparatus for a graph database. The graph database stores a first graph. The first graph includes a plurality of nodes and an edge connecting the plurality of nodes. The plurality of nodes include a first node. The method includes: obtaining a first identifier corresponding to the first node; obtaining a storage location of first property information from a pre-established inverted index based on at least the first identifier, where the first property information is property information of the first node or property information of a first edge whose endpoint is the first node, and at least the first identifier and the storage location of the first property information are stored in the inverted index in an associated manner; and obtaining the first property information based on the storage location.

This specification claims priority to Chinese Patent Application No. 202111468911.3, filed with the China National Intellectual Property Administration on Dec. 3, 2021 and entitled “RETRIEVAL METHOD AND APPARATUS FOR GRAPH DATABASE”, which is incorporated herein by reference in its entirety.

### TECHNICAL FIELD

One or more embodiments of this specification relate to the field of graph databases, and in particular, to a retrieval method and apparatus for a graph database.

### BACKGROUND

A graph database is a non-relational NoSQL database. The graph database stores relationship information between entities based on graph theory, for example, stores relationship data between people in a social network. When such relationship data is stored in a conventional relational SQL database, a data processing effect is poor. For example, an association relationship is usually queried in a relational database based on table join. However, a table join operation is costly, involves a large quantity of IO operations, and consumes a large part of a memory, resulting in relatively complex and slow query of the association relationship. However, the graph database stores a relationship between entities in a more direct and natural manner. Therefore, modeling and processing of relationship data is more convenient, and a disadvantage of the relationship data is resolved.

However, in an existing graph database solution, there is also a problem of relatively high computational costs for data retrieval and data access that retrieval depends on.

Therefore, a new retrieval method for the graph databases is needed.

### SUMMARY

Embodiments of this specification are intended to provide a new retrieval method for a graph database and a data storage and access method corresponding to the retrieval method, to reduce consumption of computing resources for data retrieval and data maintenance in the graph database, and resolve a disadvantage in the existing technology.

According to a first aspect, a retrieval method for a graph database is provided. The graph database stores a first graph. The first graph includes a plurality of nodes and an edge connecting the plurality of nodes. The plurality of nodes include a first node. The method includes:
obtaining a first identifier corresponding to the first node;
obtaining a storage location of first property information from a pre-established inverted index based on at least the first identifier, where the first property information is property information of the first node or property information of a first edge whose endpoint is the first node, and at least the first identifier and the storage location of the first property information are stored in the inverted index in an associated manner; and
obtaining the first property information based on the storage location.

In a possible implementation, the first property information is stored in a first file, and the storage location of the first property information includes a file number corresponding to the first file and an offset address corresponding to the first property information in the first file; and
the obtaining the first property information based on the storage location includes:

determining the first file from at least one storage file based on the file number; and
obtaining the first property information from the first file based on the offset address.

In a possible implementation, the inverted index includes several index records, a single index record corresponds to one object in the first graph, and the object is a node or an edge;
the index record includes a first key field, a second key field, and an address field, and the first key field is used to store an identifier of a node corresponding to the index record or an identifier of a first endpoint of an edge corresponding to the index record;
the second key field includes a first type identifier bit, and the first type identifier bit is used to identify whether an object corresponding to the index record is an edge or a node; and
the address field is used to store a storage location of property information of the object.

In a possible implementation, the obtaining a storage location of first property information from a pre-established inverted index based on at least the first identifier includes:
if the first property information is the property information of the first node,
determining, from the pre-established inverted index, a first index record in which a first key field stores a first identifier, and an object identified by a first type identifier bit is a node; and
determining the storage location of the first property information based on an address field in the first index record.

In a possible implementation, the obtaining a storage location of first property information from a pre-established inverted index based on at least the first identifier includes:
if the first property information is the property information of the first edge whose endpoint is the first node,
determining, from the pre-established inverted index, a second index record in which a first key field stores a first identifier, and an object identified by a first type identifier bit is an edge; and
determining the storage location of the first property information based on an address field in the second index record.

In a possible implementation, the second key field further includes a second type identifier bit, and if the object is an edge, and the first graph is a directed graph, the second type identifier bit is used to identify a direction of the edge corresponding to the index record.

In a possible implementation, the obtaining a storage location of first property information from a pre-established inverted index based on at least the first identifier includes:
if the first property information is the property information of the first edge whose endpoint is the first node,
determining a third index record from the pre-established inverted index, where in the third index record, a first key field stores a first identifier, an object identified by a first type identifier bit is an edge, and a direction that is of the edge and that is identified by a second type identifier bit is a first direction that is known in advance; and
determining the storage location of the first property information based on an address field in the first index record.

In a possible implementation, the first direction is an incoming edge or an outgoing edge.

In a possible implementation, the second key field further includes a label identifier bit and/or a timestamp identifier bit, and the label identifier bit and the timestamp identifier bit are respectively used to identify a classification label and a generation time of the object corresponding to the index record.

In a possible implementation, the obtaining a storage location of first property information from a pre-established inverted index based on at least the first identifier includes:
if the first property information is the property information of the first edge whose endpoint is the first node,
determining a first index record from the pre-established inverted index, where in the first index record, a first key field stores a first identifier, an object identified by a first type identifier bit is an edge, and a generation time identified by a timestamp identifier bit falls within a first time period that is known in advance; and
determining the storage location of the first property information based on an address field in the first index record.

In a possible implementation, the obtaining a storage location of first property information from a pre-established inverted index based on at least the first identifier includes:
if the first property information is the property information of the first edge whose endpoint is the first node,
determining a second index record from the pre-established inverted index, where in the second index record, a first key field stores a first identifier, an object identified by a first type identifier bit is an edge, and a classification label identified by a label identifier bit is a first label that is known in advance; and
determining the storage location of the first property information based on an address field in the second index record.

In a possible implementation, the first key field is of an int type.

In a possible implementation, the second key field is of a long type.

In a possible implementation, the first graph is a directed graph; and the first edge is an edge whose start point is the first node.

In a possible implementation, the inverted index is stored in a memory.

In a possible implementation, the inverted index is divided, based on an identifier of a node, into a plurality of index pages stored in the memory, and each index page stores a predetermined quantity of index records.

In a possible implementation, the method further includes:
when a capacity of the inverted index exceeds a predetermined first memory capacity threshold,
determining several dump index pages from the plurality of index pages, and dumping the dump index pages from the memory to a permanent storage.

In a possible implementation, the method further includes:
if a total capacity of the index pages that are of the inverted index and that are stored in the memory is less than a predetermined second memory capacity threshold, and the dump index pages are stored in permanent storage space,
determining several restoration index pages from the dump index pages, and dumping the restoration index pages from the permanent storage to the memory.

In a possible implementation, the first file includes several property records, a single property record corresponds to one object, and includes property information of the object, and the object is a node or an edge in the first graph.

In a possible implementation, if the object is an edge, the property record further includes an identifier of a node at the other end of the edge.

In a possible implementation, the first file is compressed into blocks and then stored in a permanent storage.

In a possible implementation, the obtaining the first property information from the first file based on the offset address includes:
determining, based on the offset address, a first file block of the first file to which the first property information belongs;
extracting a compressed file block corresponding to the first file block from the permanent storage, and decompressing the compressed file block to obtain the first file block; and
obtaining the first property information from the first file block.

According to a second aspect, a retrieval apparatus for a graph database is provided. The graph database stores a first graph. The first graph includes a plurality of nodes and an edge connecting the plurality of nodes. The plurality of nodes include a first node. The apparatus includes:
an identifier obtaining unit, configured to obtain a first identifier corresponding to the first node;
a storage location obtaining unit, configured to obtain a storage location of first property information from a pre-established inverted index based on at least the first identifier, where the first property information is property information of the first node or property information of a first edge whose endpoint is the first node, and at least the first identifier and the storage location of the first property information are stored in the inverted index in an associated manner; and
a property information obtaining unit, configured to obtain the first property information based on the storage location.

According to a third aspect, a computer-readable storage medium is provided. The computer-readable storage medium stores a computer program. When the computer program is executed in a computer, the computer is enabled to perform the method according to the first aspect.

According to a fourth aspect, a computing device is provided, and includes a storage and a processor. The storage stores executable code. When the processor executes the executable code, the method according to the first aspect is implemented.

By using one or more of the method, the apparatus, the computing device, and the storage medium in the foregoing aspects, computing resources consumed for data retrieval and maintenance in the graph database can be effectively reduced, to increase a processing amount and a processing speed of graph data.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following description show merely some embodiments of this specification, and a person of ordinary skill in the art can derive other drawings from these accompanying drawings without creative efforts.

FIG. 1 is a schematic diagram of a principle of an existing retrieval method for a graph database;

FIG. 2 is a schematic diagram of a principle of a retrieval method for a graph database according to an embodiment of this specification;

FIG. 3 is a flowchart of a retrieval method for a graph database according to an embodiment of this specification;

FIG. 4 is a structural diagram of a second key field according to an embodiment of this specification; and

FIG. 5 is a structural diagram of a retrieval apparatus for a graph database according to an embodiment of this specification.

### DESCRIPTION OF EMBODIMENTS

The solutions provided in this specification are described below with reference to the accompanying drawings.

As described above, when a relationship, particularly a multi-layer relationship, between data needs to be processed and stored, a conventional relational database usually needs to use a large quantity of join operations, and therefore performance consumption is very high. Particularly, when a large amount of data is processed, processing efficiency is unsatisfactory.

Therefore, in some technical solutions, a graph database is used to protect and process data and a relationship between the data. The graph database stores a graph that includes nodes and an edge between the nodes, to directly store the data and the relationship between the data. Compared with a manner in which in a conventional database, different tables are linked by consuming join operations, to implicitly express a relationship between data, in the direct relationship representation manner in the graph database, significantly higher processing efficiency is achieved when the data and the relationship between the data are processed by using the graph database.

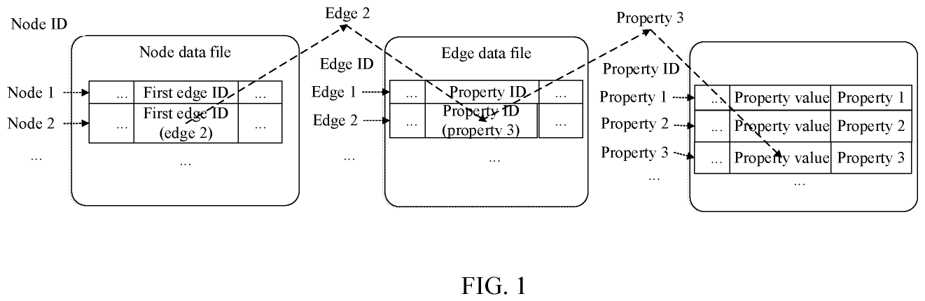

However, the inventors find, through research, that in some graph database solutions, there is also a problem of relatively high computational costs for data retrieval and data access that retrieval depends on. A graph database solution is used as an example. In this technical solution, data such as a node, a relationship (edge), and a property (property of the node or the relationship) in a graph stored in a database is respectively stored in different types of data storage files. In an example, for example, the node, the relationship, and the property data are respectively stored in a node data file nodestore.db, an edge data file relationshipstore.db, and a property data file propertystore.db. In addition, internally maintained identifiers (IDs) are established for all properties, nodes, and edges, and the properties, nodes, and edges are accessed by using the IDs. FIG. 1 is a schematic diagram of a principle of a retrieval method for a graph database. As shown in FIG. 1, for example, when a node is known, and a property of an edge (for example, a first edge) whose endpoint is the node (for example, whose start point is the node) needs to be obtained, based on an ID of the node (for example, a node 2, where ‘node 2’ is merely used for ease of description, and does not imply a data type of the ID), an ID, for example, ‘edge 2’, of the first edge of ‘node 2’ can be first found from a node data file. Then, based on the edge ID ‘edge 2’, an ID, for example, ‘property 3’, of a property of ‘edge 2’ is found from an edge data file. Finally, a property value of ‘property 3’ is found from a property data file based on ‘property 3’. It can be learned from the foregoing process that the following problems exist: 1. IDs need to be established for all types of data, and ID conversion needs to be performed to perform further data processing of the data. Computational performance consumption accumulated for establishing the IDs for all the data is relatively high, and a total amount of data that can be processed by the graph database is limited. 2. All information is stored in data storage files, and overheads of accessing and maintaining these data storage files are very high. The data storage files usually have a relatively large amount of data, and therefore are usually stored in a permanent storage (for example, a disk). During each time of access, the disk needs to be accessed. It is relatively slow to access the disk. Consequently, an overall data access and processing speed is relatively low. 3. Data retrieval usually requires a jump to a plurality of data storage files. An address of a next piece of information that needs to be accessed needs to be determined each time by accessing a file. In this chain-based file reading manner, access overheads are also very high.

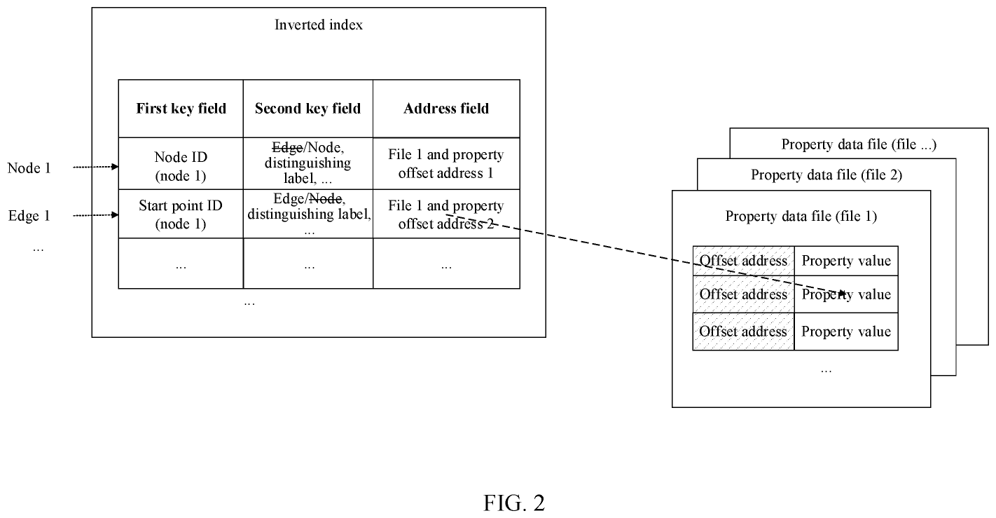

To resolve the foregoing technical problem, the embodiments of this specification provide a retrieval method for a graph database. A core idea of the method is as follows: An inverted index used for retrieval is established in a memory, and then storage addresses of properties of nodes and edges can be directly retrieved based on the inverted index, to obtain the properties of the nodes and the edges by using very low computational consumption. FIG. 2 is a schematic diagram of a principle of a retrieval method for a graph database according to an embodiment of this specification. In the embodiment shown in FIG. 2, each index in an inverted index can correspond to one node or one edge, and each record can include, for example, three fields. A first key field stores a node ID or stores, for example, a start point ID of an edge. A second key field can include an identifier bit used to indicate whether the record corresponds to a node or an edge, and can further include, for example, a classification label identifier bit of the node/edge, and the like. A third field includes a storage address of property data of the node/edge corresponding to the record. In an embodiment, the third field includes, for example, a file number of a property data file in which the property data is stored and an offset address of the property data in the file. It can be learned from the foregoing descriptions that the first field and the second field are mainly used to indicate a node or an edge to which the property belongs, and the third field is used to store an address of the property. Therefore, in this specification, the first field and the second field are also referred to as a first key field and a second key field, and the third field is referred to as an address field. It should be noted that the first and second ‘key’ fields herein are merely used for the convenience of expressing the foregoing meaning of indication, and are not equivalent to implying that the first and second ‘key’ fields need to be hash values, just like some specific keys (for example, ‘keys in key-value pairs’ in a hash table).

Therefore, in actual retrieval, for example, when a property of an edge whose start point is a node 1 needs to be retrieved, an index record corresponding to the edge can be quickly retrieved from the inverted index by using an ID of the node 1 and another condition of the edge (for example, a classification (category) label of the edge and a direction of the edge), and then a storage address, for example, a number (for example, a file 1) of a file and an offset address in the file, of the property of the edge can be obtained from an address field in the record, to quickly extract property data of the edge from the file 1. Algorithmic complexity of the entire retrieval operation is theoretically approximately O (1).

It can be learned that the method has the following advantages: 1. IDs are established only for a small amount of data, for example, for nodes, so that computational overheads for establishing IDs for data in data processing are greatly reduced, to increase a data processing amount of the graph database. 2. The inverted index is mainly stored in a memory. Particularly, when there is a relatively small amount of data, the inverted index can be completely stored in the memory. Therefore, retrieval is performed by using the inverted index, and retrieval efficiency is greatly improved compared with that in a manner in which retrieval is performed by using data storage files stored in a hard disk (the data storage files are usually relatively large, and therefore it is difficult to completely place the data storage files in the memory). 3. A target index record can be quickly retrieved from the inverted index by using a node ID/start point ID or some additional conditions, and a location of data that needs to be accessed can be directly located from an address field in the target index record. Compared with the existing technology in which a plurality of jumps usually need to be made in a plurality of data storage files to retrieve a final result, overheads of file access are greatly reduced.

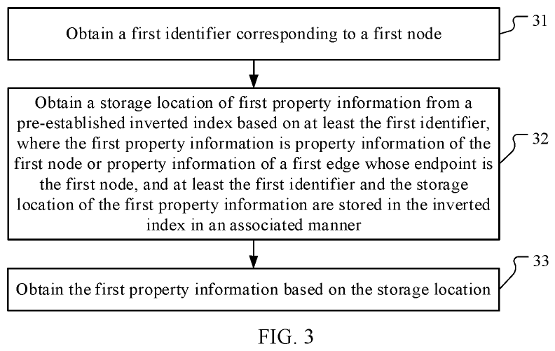

The following further describes a detailed process of the method. FIG. 3 is a flowchart of a retrieval method for a graph database according to an embodiment of this specification. As shown in FIG. 3, the method includes at least the following steps.

Step 31: Obtain a first identifier corresponding to a first node.

Step 32: Obtain a storage location of first property information from a pre-established inverted index based on at least the first identifier, where the first property information is property information of the first node or property information of a first edge whose endpoint is the first node, and at least the first identifier and the storage location of the first property information are stored in the inverted index in an associated manner.

Step 33: Obtain the first property information based on the storage location.

First, in step 31, the first identifier corresponding to the first node is obtained.

In this step, the first node can be any node in any graph in the graph database. For any node, there is a node identifier, namely, a node ID, corresponding to the node. The first identifier is a node ID corresponding to the first node. In different types of embodiments, the node ID can be of different data types. In a specific embodiment, the data type of the node ID can be an integer type, for example, a short type, an int type, or a long type.

Then, in step 32, the storage location of the first property information is obtained from the pre-established inverted index based on at least the first identifier.

In this step, a node/edge and a storage address of a property of the node/edge can be stored in the pre-established inverted index in an associated manner. In an implementation, the inverted index can include several index records, a single index record corresponds to one object in a first graph, and the object is a node or an edge; the index record can include a first key field, a second key field, and an address field, and the first key field is used to store an identifier of a node corresponding to the index record or an identifier of a first endpoint of an edge corresponding to the index record; the second key field includes a first type identifier bit, and the first type identifier bit is used to identify whether an object corresponding to the index record is an edge or a node; and the address field is used to store a storage location of property information of the object.

Further, in an embodiment, if the first property information is the property information of the first node, a first index record in which a first key field stores a first identifier, and an object identified by a first type identifier bit is a node can be determined from the pre-established inverted index; and then the storage location of the first property information can be determined based on an address field in the first index record. In another embodiment, if the first property information is the property information of the first edge whose endpoint is the first node, a second index record in which a first key field stores a first identifier, and an object identified by a first type identifier bit is an edge can be determined from the pre-established inverted index; and the storage location of the first property information can be determined based on an address field in the second index record.

In different embodiments, the graph stored in the graph database can be a directed graph. To facilitate retrieval in the directed graph based on a direction of an edge, in an embodiment, the second key field can further include a second type identifier bit, and if the object is an edge, and the first graph is a directed graph, the second type identifier bit is used to identify a direction of the edge corresponding to the index record. The direction of the edge can be an incoming edge or an outgoing edge. The incoming edge means that a direction of the edge is from another node to a node, for example, the first node, recorded in the first key field in the index record, that is, the first node is used as an endpoint. The outgoing edge means that a direction of the edge is from the first node to another node, that is, the first node is used as a start point.

In a specific embodiment, if the first property information is the property information of the first edge whose endpoint is the first node, a third index record can be determined from the pre-established inverted index, where in the third index record, a first key field stores a first identifier, an object identified by a first type identifier bit is an edge, and a direction identified by a second type identifier bit is a first direction that is known in advance; and the storage location of the first property information can be determined based on an address field in the third index record. In this way, the storage location of the first property information is determined by using the first direction that is known in advance as a further retrieval condition. In a specific embodiment, the first graph is a directed graph; and the first edge is an edge whose start point is the first node.

In different embodiments, a classification identifier and/or a generation timestamp of the node and/or the edge can be further stored in the inverted index, and is used to determine a corresponding index record of the node or the edge based on the classification identifier and/or the generation timestamp during retrieval. Therefore, in an embodiment, the second key field further includes a label identifier bit and/or a timestamp identifier bit, and the label identifier bit and the timestamp identifier bit are respectively used to identify a classification label and a generation time of the object corresponding to the index record. In a specific embodiment, if the first property information is the property information of the first edge whose endpoint is the first node, a first index record can be determined from the pre-established inverted index, where in the first index record, a first key field stores a first identifier, an object identified by a first type identifier bit is an edge, and a generation time identified by a timestamp identifier bit falls within a first time period that is known in advance; and then the storage location of the first property information can be determined based on an address field in the first index record. In this way, a storage location of property information corresponding to a target connection edge generated in a predetermined time period is quickly determined by using a time period (a time period to which a timestamp of an edge belongs) in which a relationship is generated as a further retrieval condition.

In another specific embodiment, if the first property information is the property information of the first edge whose endpoint is the first node, a second index record can be determined from the pre-established inverted index, where in the second index record, a first key field stores a first identifier, an object identified by a first type identifier bit is an edge, and a classification label identified by a label identifier bit is a first label that is known in advance; and the storage location of the first property information can be determined based on an address field in the second index record. In this way, a storage location of property information corresponding to a target connection edge of a predetermined type is quickly determined by using a type of a relationship (a label of an edge) as a further retrieval condition.

As described above, in different embodiments, the node ID can be of different data types. Correspondingly, in different embodiments, the first key field can be correspondingly of different data types. In addition, in different embodiments, the second key field can also be of different data types. In an embodiment, the first key field can be of an int type, and the second key field can be of a long type.

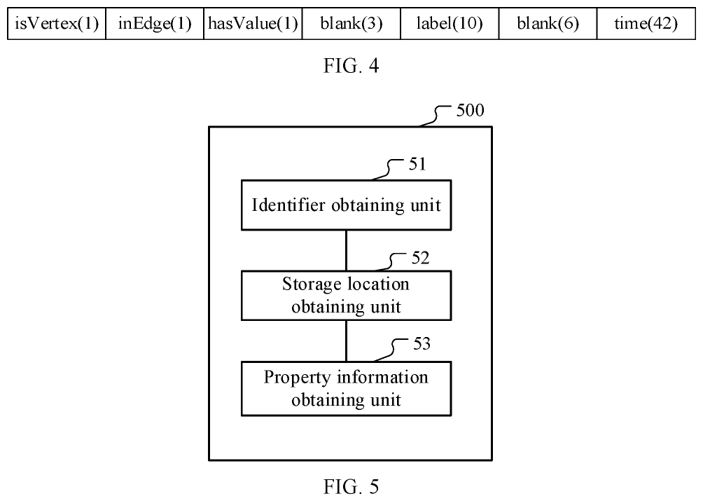

FIG. 4 is a structural diagram of a second key field according to an embodiment of this specification. As shown in FIG. 4, the second key field is a long-type field (64 bits), includes a 1-bit first type identifier bit is Vertex(1) and a 1-bit second type identifier bit inEdge(1), and further includes a 1-bit value identifier bit has Value(1), a 10-bit classification label identifier bit label(10), a 42-bit timestamp identifier bit time(42), a 3-bit blank bit blank(3) between the value identifier bit and the classification label identifier bit, and a 6-bit blank bit blank(6) between the classification label identifier bit and the timestamp identifier bit. Specifically, for example, when a value of the first type identifier bit is ‘1’, it indicates that the index record corresponds to a node; or when a value of the first type identifier bit is ‘0’, it indicates that the index record corresponds to an edge. For example, when a value of the second type identifier bit is ‘1’, it indicates that a direction of an edge corresponding to the index record is an incoming edge; or when a value of the second type identifier bit is ‘0’, it indicates that a direction of an object (a node/edge) corresponding to the index record is an outgoing edge. For example, when a value of the value identifier bit is ‘1’, it indicates that the object (node/edge) corresponding to the index record has property data stored in a property file. Therefore, for example, a storage address of the property data can be determined based on an address field in the index record. When a value of the value identifier bit is ‘0’, it indicates that the object (node/edge) corresponding to the index record does not have property data stored in a property file. Therefore, no further search is needed for the data. The classification label identifier bit and the timestamp identifier bit are respectively used to store a classification label and a generation timestamp of the object (node/edge) corresponding to the index record. In different embodiments, the classification label and the generation timestamp can have different encoding manners. This is not limited in this specification. In different embodiments, the second key field can also have different specific structures. This is not limited in this specification.

It can be understood that a speed of a memory access operation is usually much greater than that of a permanent storage (for example, a hard disk). When the inverted index is placed in a memory for graph data retrieval, a retrieval speed can be greatly increased. Therefore, in an embodiment, the inverted index can be stored in the memory. Specifically, in an embodiment, the inverted index can be divided, based on an identifier of a node, into a plurality of index pages stored in the memory, and each index page stores a predetermined quantity of index records. In an example, for example, each index page stores 1000 index records.

However, if a capacity of the inverted index exceeds a specific range, and it is difficult to completely store the inverted index in the memory, a part of the inverted index can be dumped to the permanent storage. Therefore, in an embodiment, when the capacity of the inverted index exceeds a predetermined first memory capacity threshold, several dump index pages can be determined from the plurality of index pages, and the dump index pages can be dumped from the memory to the permanent storage. In subsequent running, for example, when a capacity of the index pages stored in the memory decreases, the index pages dumped to the permanent storage can be restored in the memory. Therefore, in another embodiment, if a total capacity of the index pages that are of the inverted index and that are stored in the memory is less than a predetermined second memory capacity threshold, and the dump index pages are stored in permanent storage space, several restoration index pages can be determined from the dump index pages, and the restoration index pages can be dumped from the permanent storage to the memory.

Then, in step 33, the first property information is obtained based on the storage location.

Property information in the graph database is stored in a property data file. An amount of data in the property information in the graph database is usually relatively large, and therefore there can be a plurality of property data files. Therefore, in an embodiment, the first property information can be stored in a first file, and the storage location of the first property information can include a file number corresponding to the first file and an offset address corresponding to the first property information in the first file; the first file is determined from at least one storage file based on the file number; and the first property information is obtained from the first file based on the offset address. In an embodiment, the first file can include several property records, a single property record corresponds to one object, and includes property information of the object, and the object is a node or an edge in the first graph. In an embodiment, if the object is an edge, the property record can further include an identifier of a node at the other end of the edge.

In different embodiments, the property storage file can be stored in different storages, for example, the memory and the permanent storage. In an embodiment, the property storage file usually also has a relatively large amount of data, and therefore the property storage file usually can be stored in the permanent storage. The permanent storage described in this specification is a storage in which stored content is not lost after power is off, for example, a hard disk, a removable hard disk, a flash memory, and a permanent storage card such as a TF card and an SD card. In different specific embodiments, different specific permanent storages can be used. This is not limited in this specification.

To increase an access speed of the property data, the property storage file can be stored in blocks, so that when specific property data is accessed, only a file block to which the specific property data belongs needs to be accessed, and there is no need to perform an operation on the entire property storage file. Therefore, in an embodiment, the first file can be compressed into blocks and then stored in a permanent storage. Further, in a specific embodiment, a first file block of the first file to which the first property information belongs can be determined based on the offset address; a compressed file block corresponding to the first file block can be extracted from the permanent storage, and the compressed file block can be decompressed to obtain the first file block; and the first property information can be obtained from the first file block. For example, in an example, if property information whose offset address is 1000 in a property file whose file number is 3 is expected to be extracted, the property file whose file number is 3 can be found, a compressed file block corresponding to a file block to which the offset address 1000 in the file belongs can be determined, the compressed file block can be decompressed, and the property information whose offset address is 1000 can be obtained from the compressed file block. In an actual production scenario, the property information usually has a specific data type (for example, an object type), or includes a further refined property item. In different embodiments, the property information can have different specific data types and specific property items. This is not limited in this specification. In different embodiments, the property information can be parsed based on a structure of a specific data type and division of a specific property item. A specific parsing manner is not limited in this specification.

According to an embodiment in another aspect, a retrieval apparatus for a graph database is further provided. FIG. 5 is a structural diagram of a retrieval apparatus for a graph database according to an embodiment of this specification. The graph database stores a first graph. The first graph includes a plurality of nodes and an edge connecting the plurality of nodes. The plurality of nodes include a first node. As shown in FIG. 5, the apparatus 500 includes:
an identifier obtaining unit 51, configured to obtain a first identifier corresponding to the first node;
a storage location obtaining unit 52, configured to obtain a storage location of first property information from a pre-established inverted index based on at least the first identifier, where the first property information is property information of the first node or property information of a first edge whose endpoint is the first node, and at least the first identifier and the storage location of the first property information are stored in the inverted index in an associated manner; and
a property information obtaining unit 53, configured to obtain the first property information based on the storage location.

In an embodiment, the first property information can be stored in a first file, and the storage location of the first property information includes a file number corresponding to the first file and an offset address corresponding to the first property information in the first file; and
the obtaining the first property information based on the storage location includes:
determining the first file from at least one storage file based on the file number; and
obtaining the first property information from the first file based on the offset address.

In an embodiment, the inverted index can include several index records, a single index record corresponds to one object in the first graph, and the object is a node or an edge;
the index record includes a first key field, a second key field, and an address field, and the first key field is used to store an identifier of a node corresponding to the index record or an identifier of a first endpoint of an edge corresponding to the index record;
the second key field includes a first type identifier bit, and the first type identifier bit is used to identify whether an object corresponding to the index record is an edge or a node; and
the address field is used to store a storage location of property information of the object.

In an embodiment, the storage location obtaining unit can be further configured to:
if the first property information is the property information of the first node,
determine, from the pre-established inverted index, a first index record in which a first key field stores a first identifier, and an object identified by a first type identifier bit is a node; and
determine the storage location of the first property information based on an address field in the first index record.

In an embodiment, the storage location obtaining unit can be further configured to:
if the first property information is the property information of the first edge whose endpoint is the first node,
determine, from the pre-established inverted index, a second index record in which a first key field stores a first identifier, and an object identified by a first type identifier bit is an edge; and
determine the storage location of the first property information based on an address field in the second index record.

In an embodiment, the second key field can further include a second type identifier bit, and if the object is an edge, and the first graph is a directed graph, the second type identifier bit is used to identify a direction of the edge corresponding to the index record.

In an embodiment, the storage location obtaining unit can be further configured to:
if the first property information is the property information of the first edge whose endpoint is the first node,
determine a third index record from the pre-established inverted index, where in the third index record, a first key field stores a first identifier, an object identified by a first type identifier bit is an edge, and a direction that is of the edge and that is identified by a second type identifier bit is a first direction that is known in advance; and
determine the storage location of the first property information based on an address field in the first index record.

In an embodiment, the first direction is an incoming edge or an outgoing edge.

In an embodiment, the second key field further includes a label identifier bit and/or a timestamp identifier bit, and the label identifier bit and the timestamp identifier bit are respectively used to identify a classification label and a generation time of the object corresponding to the index record.

In an embodiment, the storage location obtaining unit can be further configured to:
if the first property information is the property information of the first edge whose endpoint is the first node,
determine a first index record from the pre-established inverted index, where in the first index record, a first key field stores a first identifier, an object identified by a first type identifier bit is an edge, and a generation time identified by a timestamp identifier bit falls within a first time period that is known in advance; and determine the storage location of the first property information based on an address field in the first index record.

In an embodiment, the storage location obtaining unit can be further configured to:
if the first property information is the property information of the first edge whose endpoint is the first node,
determine a second index record from the pre-established inverted index, where in the second index record, a first key field stores a first identifier, an object identified by a first type identifier bit is an edge, and a classification label identified by a label identifier bit is a first label that is known in advance; and determine the storage location of the first property information based on an address field in the second index record.

In an embodiment, the first key field can be of an int type.

In an embodiment, the second key field can be of a long type.

In an embodiment, the first graph is a directed graph; and the first edge is an edge whose start point is the first node.

In an embodiment, the inverted index is stored in a memory.

In an embodiment, the inverted index is divided, based on an identifier of a node, into a plurality of index pages stored in the memory, and each index page stores a predetermined quantity of index records.

In an embodiment, the apparatus further includes a dump unit, which can be configured to:
when a capacity of the inverted index exceeds a predetermined first memory capacity threshold,
determine several dump index pages from the plurality of index pages, and dump the dump index pages from the memory to a permanent storage.

In an embodiment, the apparatus further includes a restoration unit, which can be configured to:
if a total capacity of the index pages that are of the inverted index and that are stored in the memory is less than a predetermined second memory capacity threshold, and the dump index pages are stored in permanent storage space,
determine several restoration index pages from the dump index pages, and dump the restoration index pages from the permanent storage to the memory.

In an embodiment, the first file can include several property records, a single property record corresponds to one object, and includes property information of the object, and the object is a node or an edge in the first graph.

In an embodiment, if the object is an edge, the property record further includes an identifier of a node at the other end of the edge.

In an embodiment, the first file is compressed into blocks and then stored in a permanent storage.

In an embodiment, the property information obtaining unit can be further configured to determine, based on the offset address, a first file block of the first file to which the first property information belongs; extract a compressed file block corresponding to the first file block from the permanent storage, and decompress the compressed file block to obtain the first file block; and obtain the first property information from the first file block.

According to still another aspect of this specification, a computer-readable storage medium is provided. The computer-readable storage medium stores a computer program. When the computer program is executed in a computer, the computer is enabled to perform any one of the foregoing methods.

According to yet another aspect of this specification, a computing device is provided, and includes a storage and a processor. The storage stores executable code. When the processor executes the executable code, any one of the foregoing methods is implemented.

It should be understood that descriptions such as “first” and “second” in this specification are merely intended to distinguish between similar concepts for ease of description, and do not impose a limitation.

A person skilled in the art should be aware that in the foregoing one or more examples, functions described in this specification can be implemented by hardware, software, firmware, or any combination thereof. When being implemented by software, these functions can be stored in a computer-readable medium or transmitted as one or more instructions or code on a computer-readable medium.

The objectives, technical solutions, and beneficial effects of this specification are further described in detail in the foregoing specific implementations. It should be understood that the foregoing descriptions are merely specific implementations of this specification, but are not intended to limit the protection scope of this specification. Any modification, equivalent replacement, improvement, and the like made based on the technical solutions of this specification shall fall within the protection scope of this specification.

1. A retrieval method for a graph database, wherein the graph database stores a first graph, the first graph comprises a plurality of nodes and an edge connecting the plurality of nodes, the plurality of nodes comprise a first node, and the method comprises:
obtaining a first identifier corresponding to the first node;
obtaining a storage location of first property information from a pre-established inverted index based on at least the first identifier, wherein the first property information is property information of the first node or property information of a first edge whose endpoint is the first node, and at least the first identifier and the storage location of the first property information are stored in the inverted index in an associated manner; and
obtaining the first property information based on the storage location.

2. The method according to claim 1, wherein the first property information is stored in a first file, and the storage location of the first property information comprises a file number corresponding to the first file and an offset address corresponding to the first property information in the first file; and
the obtaining the first property information based on the storage location comprises:
determining the first file from at least one storage file based on the file number; and
obtaining the first property information from the first file based on the offset address.

3. The method according to claim 1, wherein the inverted index comprises a plurality of index records, a single index record corresponds to one object in the first graph, and the object is a node or an edge;
the index record comprises a first key field, a second key field, and an address field, and the first key field is used to store an identifier of a node corresponding to the index record or an identifier of a first endpoint of an edge corresponding to the index record;
the second key field comprises a first type identifier bit, and the first type identifier bit is used to identify whether an object corresponding to the index record is an edge or a node; and
the address field is used to store a storage location of property information of the object.

4. The method according to claim 3, wherein
the obtaining a storage location of first property information from a pre-established inverted index based on at least the first identifier comprises:
upon determining that the first property information is the property information of the first node,
determining a first index record from the plurality of index records, wherein in the first index record, a first key field stores a first identifier, and an object identified by a first type identifier bit is a node; and
determining the storage location of the first property information based on an address field in the first index record.

5. The method according to claim 3, wherein
the obtaining a storage location of first property information from a pre-established inverted index based on at least the first identifier comprises:
upon determining that the first property information is the property information of the first edge whose endpoint is the first node,
determining a second index record from the plurality of index records, wherein in the second index record, a first key field stores a first identifier, and an object identified by a first type identifier bit is an edge; and
determining the storage location of the first property information based on an address field in the second index record.

6. The method according to claim 3, wherein the second key field further comprises a second type identifier bit, and upon determining that the object is an edge, and the first graph is a directed graph, the second type identifier bit is used to identify a direction of the edge corresponding to the index record.

7. The method according to claim 6, wherein
the obtaining a storage location of first property information from a pre-established inverted index based on at least the first identifier comprises:
upon determining that the first property information is the property information of the first edge whose endpoint is the first node,
determining a third index record from the several index records, wherein in the third index record, a first key field stores a first identifier, an object identified by a first type identifier bit is an edge, and a direction identified by a second type identifier bit is a first direction that is known in advance; and
determining the storage location of the first property information based on an address field in the third index record.

8. The method according to claim 7, wherein the first direction is an incoming edge or an outgoing edge.

9. The method according to claim 3, wherein the second key field further comprises a label identifier bit and/or a timestamp identifier bit, and the label identifier bit and the timestamp identifier bit are respectively used to identify a classification label and a generation time of the object corresponding to the index record.

10. The method according to claim 9, wherein
the obtaining a storage location of first property information from a pre-established inverted index based on at least the first identifier comprises:
upon determining that the first property information is the property information of the first edge whose endpoint is the first node,
determining a first index record from the plurality of index records, wherein in the first index record, a first key field stores a first identifier, an object identified by a first type identifier bit is an edge, and a generation time identified by a timestamp identifier bit falls within a first time period that is known in advance; and
determining the storage location of the first property information based on an address field in the first index record.

11. The method according to claim 9, wherein
the obtaining a storage location of first property information from a pre-established inverted index based on at least the first identifier comprises:
upon determining that the first property information is the property information of the first edge whose endpoint is the first node,
determining a second index record from the several index records, wherein in the second index record, a first key field stores a first identifier, an object identified by a first type identifier bit is an edge, and a classification label identified by a label identifier bit is a first label that is known in advance; and
determining the storage location of the first property information based on an address field in the second index record.

12. The method according to claim 3, wherein the first key field is of an int type.

13. The method according to claim 3, wherein the second key field is of a long type.

14. The method according to claim 1, wherein the first graph is a directed graph; and the first edge is an edge whose start point is the first node.

15. The method according to claim 1, wherein the inverted index is stored in a memory.

16. The method according to claim 15, wherein the inverted index is divided, based on an identifier of a node, into a plurality of index pages stored in the memory, and each index page stores a predetermined quantity of index records.

17. The method according to claim 16, further comprising:
when a capacity of the inverted index exceeds a predetermined first memory capacity threshold,
determining a plurality of dump index pages from the plurality of index pages, and dumping the dump index pages from the memory to a permanent storage.

18. The method according to claim 17, further comprising:
upon determining that a total capacity of the index pages that are of the inverted index and that are stored in the memory is less than a predetermined second memory capacity threshold, and the dump index pages are stored in permanent storage space,
determining a plurality of restoration index pages from the dump index pages, and dumping the restoration index pages from the permanent storage to the memory.

19. The method according to claim 2, wherein the first file comprises a plurality of property records, a single property record corresponds to one object, and comprises property information of the object, and the object is a node or an edge in the first graph.

20. The method according to claim 19, wherein upon determining that the object is an edge, the property record further comprises an identifier of a node at the other end of the edge.

21. The method according to claim 2, wherein the first file is compressed into blocks and then stored in a permanent storage.

22. The method according to claim 21, wherein the obtaining the first property information from the first file based on the offset address comprises:
determining, based on the offset address, a first file block of the first file to which the first property information belongs;
extracting a compressed file block corresponding to the first file block from the permanent storage, and decompressing the compressed file block to obtain the first file block; and
obtaining the first property information from the first file block.)

23. (canceled)

24. A non-transitory computer-readable storage medium for a graph database, wherein the graph database stores a first graph, the first graph comprises a plurality of nodes and an edge connecting the plurality of nodes, the plurality of nodes comprise a first node, the non-transitory computer-readable storage medium comprising instructions stored therein that, when executed by a processor of a computing device, cause the processor to:
obtain a first identifier corresponding to the first node;
obtain a storage location of first property information from a pre-established inverted index based on at least the first identifier, wherein the first property information is property information of the first node or property information of a first edge whose endpoint is the first node, and at least the first identifier and the storage location of the first property information are stored in the inverted index in an associated manner; and
obtain the first property information based on the storage location.

25. A computing device for a graph database, wherein the graph database stores a first graph, the first graph comprises a plurality of nodes and an edge connecting the plurality of nodes, the plurality of nodes comprise a first node, the computing device comprising a memory and a processor, wherein the memory stores executable instructions that, in response to execution by the processor, cause the processor to:
obtain a first identifier corresponding to the first node;
obtain a storage location of first property information from a pre-established inverted index based on at least the first identifier, wherein the first property information is property information of the first node or property information of a first edge whose endpoint is the first node, and at least the first identifier and the storage location of the first property information are stored in the inverted index in an associated manner; and
obtain the first property information based on the storage location.
